(19) United States
(12) Patent Application Publication
(10) Pub. No.: US 2026/0336944 A1
(43) Pub. Date: Oct. 29, 2026

(54) Rotatable Conveyor Module and Methods of Operation Thereof

(71) Applicant: Thurne-Middleby Limited, Norwich (GB)

(72) Inventors: Matthew James Smith, Norwich (GB); Jacob Mark Wiggett, Norwich (GB); James Matthew Barter, Norwich (GB); James Paul Wakefield, Norwich (GB)

(21) Appl. No.: 19/656,149

(22) Filed: Apr. 23, 2026

(30) Foreign Application Priority Data
Apr. 24, 2025 (GB) 2506087.2

(51) Int. Cl. B65G 41/00

(52) U.S. Cl. CPC B65G 41/002; B65G 2201/0202; B65G 2811/097

(57) ABSTRACT

A rotatable conveyor module is provided and includes a conveyor module base and a conveyor support which is carried by the conveyor module base and rotatable relative thereto about a rotation axis. A conveyor belt is configured to travel along a belt path, wherein the belt path includes a product support portion having first and second distal ends. The conveyor support also includes a belt support structure arranged to support the conveyor belt at the first and second distal ends of the product support portion of the belt path, and the belt support structure is pivotable relative to the conveyor module base about a pivot axis which is perpendicular to the rotation axis and spaced from the first and second distal ends, so as to lower one distal end and raise the other.

### CROSS-REFERENCE TO RELATED APPLICATIONS

This application claims priority from United Kingdom Application No. 2506087.2, filed on Apr. 24, 2025, the entirety of which is hereby incorporated by reference herein.

### Field of the disclosure

The present disclosure relates to a rotatable conveyor module for a food processing line, for location in the processing line downstream of a food slicing or portioning machine.

### Background to the disclosure

When a group of food portions or slices is generated by a food slicing machine, it is preferable for the group to be presented in a shingled manner so that a part of each portion or slice will be visible to the consumer. The first-cut slice of the group will lie directly on the supporting surface, whilst each subsequent slice will overlap with the preceding slice. In order to present a shingled group in the correct orientation for handling downstream, it may be necessary to rotate the food product group through 180°, and thereby reverse its direction of presentation so that the first-cut slice of the group is at the trailing end of the group.

In some instances, groups of slices or portions of a food product may be presented to the consumer in a product pack in which the food product group is carried on a stiff sheet of material, such as a card or board. The card provides support for the group during its processing and subsequent transportation. In addition, labelling and marketing content can be provided on the surface of the card.

In particular, the card may be in the form of an “L-board” including an edge portion which is folded onto the upper surface of the food product group during preparation of the product pack. The L-board may be a flat sheet which includes a folding line defined by perforations or weakening of the board in another manner along a line which extends across the board. Each flap may be folded over by hand or by a flap-folding module in a food processing line. The L-board together with the food product group is then fed to a packaging station where they are packaged in an airtight manner.

It may be necessary to rotate the L-board together with the food product group carried on the board through 180° to be in the correct orientation for a downstream flap-folding module.

A food processing line of this form is described in the present applicant’s US patent application under publication no. US2024/0391626, which is incorporated by reference herein.

It is desirable for a food processing line to be able to manipulate and prepare a product ready for packaging at a high rate of throughput and in a reliable manner to minimise any downtime for the processing line.

### SUMMARY OF THE DISCLOSURE

The present disclosure provides a rotatable conveyor module for a food product processing line, wherein the conveyor module comprises:
a conveyor module base;
a conveyor support which is carried by the conveyor module base and rotatable relative to the conveyor module base about a rotation axis; and
a conveyor belt configured to travel along a belt path, wherein the belt path includes a product support portion having first and second distal ends,
wherein the conveyor support comprises a belt support structure arranged to support the conveyor belt at the first and second distal ends of the product support portion of the belt path, and the belt support structure is pivotable relative to the conveyor module base about a pivot axis which is perpendicular to the rotation axis and spaced from the first and second distal ends, so as to lower one distal end and raise the other.

The rotatable conveyor module is therefore able to both rotate and tilt its belt support structure. This may avoid the need to include tilting conveyor sections on adjacent modules in order to accommodate rotation of the conveyor section provided by the rotatable conveyor module. As a result, the overall length of the processing line may be reduced, reducing the length of the footprint required in a processing plant, which can often be constrained by the dimensions of the associated building.

Also, obviating the need for tilting conveyor sections on adjacent modules may increase the overall throughput speed of the processing line as the adjacent modules may be shorter.

Tilting of the belt support structure to move it clear of adjacent conveyor sections was found to be preferable to raising or lowering the entire conveyor section when seeking to provide a smooth motion. Also, a tilt mechanism can be easier to clean in comparison to a vertical lift configuration involving lubricated sliding guides for example.

As the belt support structure supports the conveyor belt at both the first and second, opposite distal ends of the product support portion of the belt path, the entire section of the conveyor belt lying in the product flow path may be tilted. During the tilting action, the locations of the first and second distal end relative to each other may be unchanged. The belt support structure may include a rigid construction for supporting the conveyor belt at the first and second distal ends, via respective rollers in contact with the conveyor belt, for example.

In some examples, the pivot axis may intersect the rotation axis. The pivot axis may extend transversely across the product flow path and more particularly may be perpendicular to the product flow path.

It will be appreciated that the conveyor belt may be implemented in various forms, for example as a plurality of parallel belts. It may be advantageous to maximise the surface area of belt in contact with each product in order to minimise any risk of a product slipping relative to the underlying belt, resulting in a loss of positional accuracy which could lead to handling errors downstream.

The conveyor support may be arranged for rotation through at least 180° about the rotation axis. For example, the conveyor support may be configured to rotate through 180° in one direction and then rotate in the opposite direction by the same amount to return to its original position. In other implementations, the conveyor support may be able to rotate through a full 360° to return to its original position.

The conveyor module may include a belt drive to drive the conveyor belt around the belt path. The belt drive may be operable to selectively drive the conveyor belt in both directions around the belt path. In this way, the module may be operable to carry a food product on the upper surface of its conveyor belt in one direction, rotate through 180° and then reverse the direction of the conveyor belt to carry the food product onwards in the same direction of travel along the product flow path in its rotated orientation.

The conveyor support may include a base portion and a tilt actuator for pivoting the belt support structure relative to the base portion. The tilt actuator may comprise a servo motor, or a pneumatic or magnetic drive, for example. The tilt actuator may be controlled to accelerate and decelerate the tilting action gradually to avoid shifting of food products relative to the conveyor belt surface.

The belt drive of the conveyor module may be mounted on the base portion of the conveyor support. Thus, the belt drive may be separate from the components tilted using the tilt actuator, in order to reduce the mass and inertia of the tilted structure.

The conveyor module base may include a rotary drive for rotating the conveyor support relative to the conveyor module base about the rotation axis.

The base portion may be supported from one lateral side only of the belt. This may facilitate removal of the conveyor belt from the opposite lateral side, minimising or avoiding the need to remove components before the conveyor belt itself can be removed.

The present disclosure also provides a method of operating a rotatable conveyor module, wherein the conveyor module includes a conveyor belt configured to travel along a belt path, the belt path including a product support portion having first and second distal ends, and a belt support structure arranged to support the conveyor belt at the first and second distal ends, and the method comprises the steps of:
driving the conveyor belt in a first direction relative to the belt support structure;
pausing the belt motion;
tilting the belt support structure about a pivot axis relative to an initial position so as to lower one distal end and raise the other distal end;
rotating the belt support structure through 180° about a rotation axis which is perpendicular to the pivot axis;
tilting the belt support structure about the pivot axis to return it to the initial position; and
driving the conveyor belt relative to the belt support structure in a second direction opposite to the first direction.

In this way, the product support portion of the conveyor belt can be moved out of alignment with adjacent conveyor sections in order to allow the product support portion to be rotated without bringing either of its distal ends into contact with adjacent conveyors.

The rotatable conveyor module may form part of a food processing line, wherein: the step of driving the conveyor belt in a first direction carries a food product onto the module from an upstream module of the processing line, the step of pausing the belt motion occurs with the food product lying on the product support portion in a first rotational orientation, and the step of driving the conveyor belt in a second direction opposite to the first direction carries the food product off the rotatable conveyor module towards a downstream module of the processing line in a second rotational orientation which is rotated through 180° about an axis parallel to the rotation axis relative to its first rotational orientation.

The rotatable conveyor module may be configured such that the step of tilting the belt support structure about a pivot axis relative to the initial position so as to lower one distal end and raise the other, opposite distal end acts to lower the upstream distal end. Accordingly, should food product to be fed onto the rotatable conveyor module whilst it is in a tilted orientation, perhaps due to a fault condition, those products will land on the conveyor belt of the rotatable conveyor module, rather than falling beneath it. This may be the case when the belt support structure is in its initial, non-rotated position and/or when it is in its rotated, reversed position, having been rotated through 180° about its rotation axis.

### BRIEF DESCRIPTION OF THE DRAWINGS

An example of a rotatable conveyor module according to the present disclosure will now be described with reference to the accompanying schematic drawings, wherein:

FIG. 1 is a perspective view of a rotatable conveyor module located in a processing line in combination with upstream and downstream conveyor modules;

FIG. 2 is a side view of the modules shown in FIG. 1; and

FIGS. 3-6 show successive stages during a process to rotate a group of food products using the rotatable conveyor module.

### DETAILED DESCRIPTION

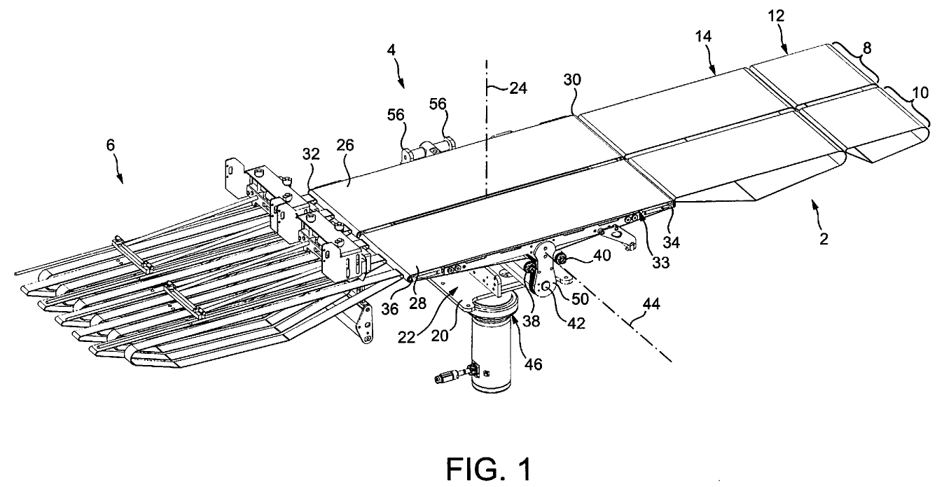

FIG. 1 shows three modules forming part of a food processing line. In this example, the modules consist of a synchronising module 2, a rotatable conveyor module 4 and a flap-folding module 6.

A food slicing machine (not shown) generates sets of shingled slices of a food product which are fed onto the synchronising module 2 and then in turn through the rotatable conveyor module 4 and the flap-folding module 6 along a product flow path. The food products are fed onto the synchronising module 2 in two parallel lanes, 8 and 10. The synchronising module includes upstream and downstream sections 12, 14 respectively, which are operable to arrange the sets of food product into a group having predetermined configuration with predefined spacings between the sets. The group is then fed to the rotatable conveyor module 4.

The rotatable conveyor module 4 has a conveyor module base 20 to be supported by the floor of a processing plant (via a supporting framework not shown in the drawings for clarity). A conveyor support 22 is carried by the conveyor module base and rotatable relative to the base about a vertical rotation axis 24. The conveyor module base includes a rotary drive 46 for rotating the conveyor support relative to the conveyor module base. The rotary drive may be a servo drive motor to provide accurate control of the position and acceleration of the conveyor support relative to the base.

The conveyor support in turn carries conveyor belts 26, 28 located in lanes 8, 10, respectively. The conveyor belts are formed of a belt material having a high friction surface, such as matt or high-gloss polyurethane, for example.

Each conveyor belt travels along a belt path which includes a product support portion extending along the product flow path between first and second distal ends 30, 32. The conveyor support includes a belt support structure 33 which has end or nose rollers 34 and 36 located at the first and second distal ends, respectively, around which the conveyor belts travel. The conveyor support also has return rollers 38 and 40 along the belt path. A belt drive 42 is located on the belt path between the rollers 38 and 40 for driving the conveyor belts.

The belt support structure may be in the form of a lightweight conveyor belt support framework. It may be constructed using materials typically used in the food industry such as stainless steel and food-approved plastics. Stainless steel components may be machine or fabricated sheet parts. A section of the structure at each distal end may be pivotable in order to de-tension the conveyor belts for removal.

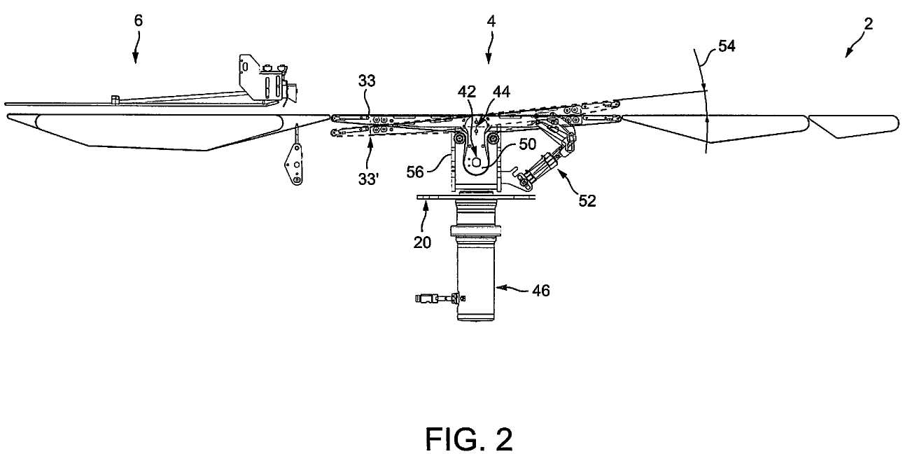

The belt support structure 33 is pivotable relative to the conveyor module base 20 about a pivot axis 44 which is perpendicular to the rotation axis 24. As can be seen in FIG. 2, the conveyor support includes a base portion 50 and a tilt actuator 52 operable to pivot the belt support structure relative to the base portion about a pivot axis 44. The tilt actuator 52 may be implemented using a wide range of actuators. The actuator may be in the form of a single actuator or more than one actuator may be deployed. The actuator may be a pneumatic or hydraulic cylinder, a magnetic solenoid, or an electric motor such as an induction or servo motor for example. A rotary motor may be used in combination with a mechanical system to convert its rotary motion into a linear action. Alternatively, a linear servo drive may be used.

In the example shown in FIG. 2, one end of the tilt actuator is coupled to a supporting framework 56 of the conveyor support and its other end is coupled to the belt support structure 33. In other examples, the actuator may drive a shaft lying on the pivot axis 44 in order to pivot the belt support structure about that axis.

The actuator may be driven so as to exhibit a motion profile such as an “S curve” to provide smooth acceleration and deceleration.

The belt support structure 33 is shown in FIG. 2 in an initial, inline configuration in which the product support portion of the conveyor belt lies in the product flow path, which may be in a horizontal configuration (e.g. substantially parallel to a floor that the system rests upon) or may be in an initial configuration that is at an acute angle with respect to the floor that the system rests upon. The belt support structure is also shown in dashed outline in a tilted configuration 33’. In the tilted configuration, the product support portion of the belt path is moved out of alignment with the two adjacent conveyor modules to facilitate rotation of the conveyor belts about rotation axis 24. FIG. 2 illustrates tilting of the product support portion so as to raise its leading, upstream end (configuration 33’) with respect to its initial position (configuration 33). Alternatively, the tilting action may lower the leading edge and raise the downstream end.

The tilt actuator may be operable to pivot the belt support structure relative to the base portion about a pivot axis 44, between two positions, so as to move one end of the structure between an initial, inline position and a lowered position (with the other end therefore moving between an inline position and a raised position). This may lower the leading, upstream end when the belt support structure is in its non-rotated configuration only, or only when it is in its 180° rotated configuration. In other implementations, the tilt actuator may be operable to pivot the belt support structure relative to the base portion about the pivot axis 44 between three positions, so as to move one end of the structure between an inline position and a lowered position, and from the inline position to a raised position. This may enable the leading, upstream end to be lowered when the belt support structure is in its non-rotated configuration and also when it is in its rotated configuration.

The extent 54 of the tilt action may be in the range of 4 to 10° away from the inline position (which may be horizontal or at an acute angle to the horizontal as discussed above), for example. The amount of tilting may be minimised to reduce the risk of products shifting relative to the surface of conveyor belts. To this end, the end rollers 34, 36 may be selected with a relatively small diameter so that only a relatively shallow tilt is required in order to move them clear of the adjacent conveyors.

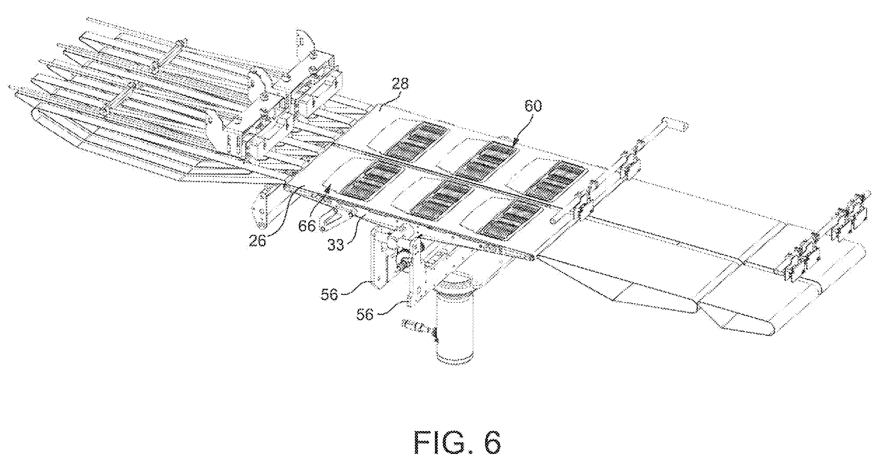

In some examples, the belt support structure 33 and base portion 50 are supported by the supporting framework 56 from one lateral side only of the belts, in a cantilevered configuration, as can be seen in FIG. 6. This facilitates removal of the conveyor belts from the opposite lateral side.

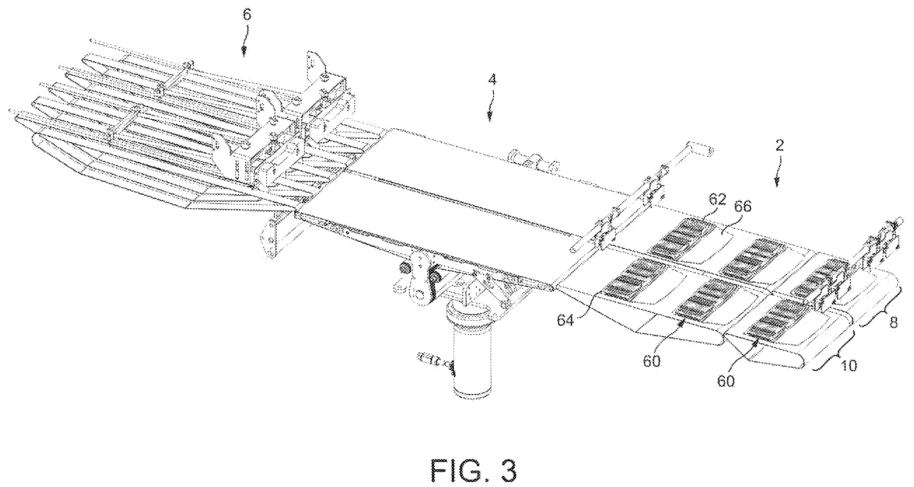

The operation of the rotatable conveyor module as part of a food processing line will now be described with reference to FIGS. 3-6.

A group of six food products 60 is shown in FIG. 3, supported by the synchronising module 2. In this example, the group format has three food products in each of the two lanes 8 and 10. Each food product consists of a set of shingled slices 62 (of bacon, for example) arranged on a supporting L-board 64. A first slice, at the leading end of each set, lies directly on the L-board 64, with each successive slice lying on top of the preceding slice, and displaced slightly along the direction of product flow relative to the preceding slice, to form a shingled set. The last slice of each set is therefore located at the trailing end of each set.

The processing line may also handle food products without an L-board present which require rotation through 180° prior to packaging. For example, each food product may be in the form of a set of shingled slices lying directly on the conveyors.

Each L-board includes a flap 66, with the L-board orientated such that the flap is upstream of the associated set of slices 62. Other package sizes, to accept shingled groups with a differing number of slices and/or slice sizes, may be used.

It will be appreciated that different numbers of product packs may be arranged in each lane to form a group, depending on the size of the product packs and the configuration of the packaging station. Modification for a different number and arrangement of product packs (such as 4 by 2) of a similar size may entail increasing the length of the synchronising module 2 and the rotatable conveyor module 4 to allow space for more product packs to be received along a line and then transferred onto the rotatable conveyor module 4. Similarly, an arrangement of, for example, 4 by 4, could be achieved by including four parallel conveyors (and related upstream and downstream structure discussed herein to receive four lanes of product packs simultaneously), as well as use of a longer rotatable conveyor module 4 if needed.

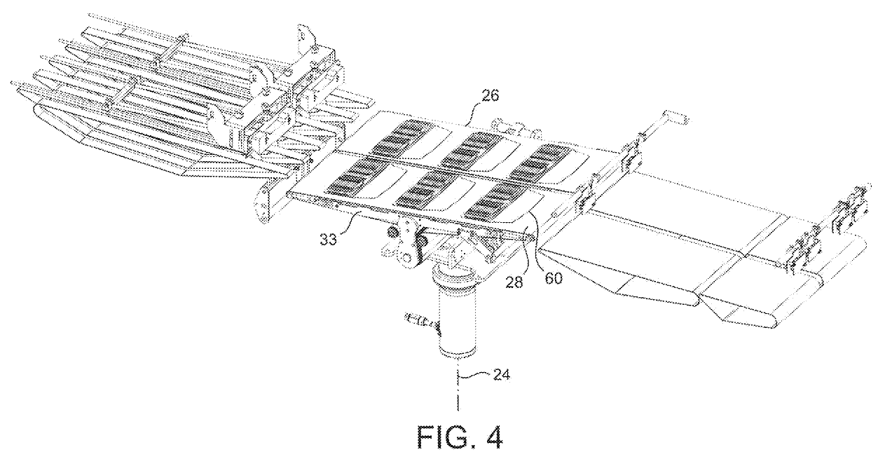

The synchronising module 2 and rotatable conveyor module 4 cooperate to move the group of food products onto the conveyor belts 26, 28 of the rotatable conveyor module. In the configuration shown in FIG. 4, the belt support structure 33 is in a tilted configuration to enable rotation thereof about rotation axis 24 without risk of collision with the adjacent modules.

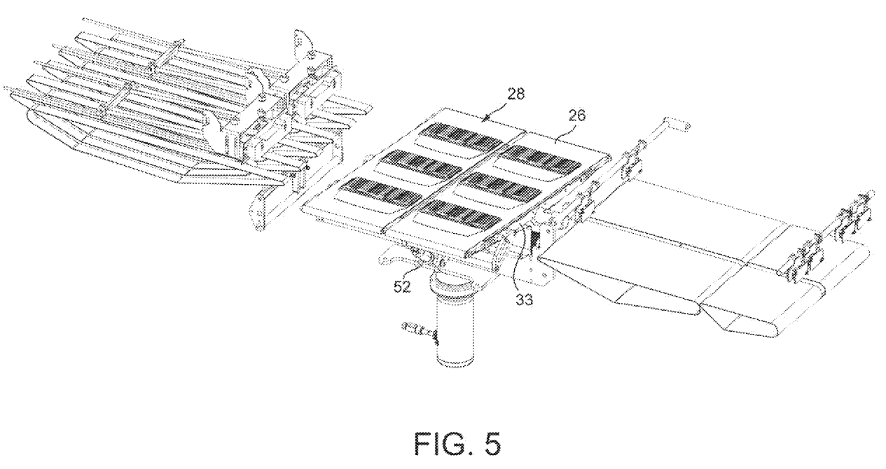

The belt support structure 33 is shown partway through its rotation in FIG. 5.

In FIG. 6, the belt support structure has been rotated through 180° and pivoted about pivot axis 44 back to its orientation in alignment with the conveyors of the adjacent modules (which is depicted as horizontal in the embodiment depicted in the figures, but may be in an orientation that is at an acute angle with respect to the horizontal as discussed above). It can be seen that the flaps 66 of the L-boards are now located downstream of the respective sets of food slices. The rotatable conveyor module 4 and the downstream flap-folding module 6 then cooperate to transport the food products onwards from the rotatable conveyor module.

Once this transfer has been completed, the rotatable conveyor module 4 receives the next set of product packs from the synchronising module 2. The conveyor support is then pivoted about pivot axis 44, rotated through 180° about axis 24, and pivoted about pivot axis 44 back to its orientation in alignment with the conveyors of the adjacent modules to return the rotatable conveyor module to its original configuration, thereby reversing the orientation of the next set of products.

It will be appreciated that references herein to perpendicular or parallel relative orientations and the like are to be interpreted as defining perpendicular or parallel relationships between components within practical tolerances.

The specification can be readily understood with reference to the following Numbered Paragraphs:

Numbered Paragraph 1. A rotatable conveyor module for a food product processing line, wherein the conveyor module comprises:
a conveyor module base;
a conveyor support which is carried by the conveyor module base and rotatable relative to the conveyor module base about a rotation axis; and
a conveyor belt configured to travel along a belt path, wherein the belt path includes a product support portion having first and second distal ends,
wherein the conveyor support comprises a belt support structure arranged to support the conveyor belt at the first and second distal ends of the product support portion of the belt path, and the belt support structure is pivotable relative to the conveyor module base about a pivot axis which is perpendicular to the rotation axis and spaced from the first and second distal ends, so as to lower one distal end and raise the other.

Numbered Paragraph 2. A conveyor module of Numbered Paragraph 1, wherein the conveyor support is rotatable through at least 180° about the rotation axis.

Numbered Paragraph 3. A conveyor module of Numbered Paragraph 1 or Numbered Paragraph 2, including a belt drive operable to selectively drive the conveyor belt in opposite first and second directions around the belt path.

Numbered Paragraph 4. A conveyor module of any preceding Numbered Paragraph, wherein the conveyor support includes a base portion and a tilt actuator for pivoting the belt support structure relative to the base portion.

Numbered Paragraph 5. A conveyor module of Numbered Paragraph 4 when dependent on Numbered Paragraph 3, wherein the belt drive is mounted on the base portion.

Numbered Paragraph 6. A conveyor module of Numbered Paragraph 4 or Numbered Paragraph 5, wherein the base portion is supported from one lateral side only of the conveyor belt.

Numbered Paragraph 7. A conveyor module of any preceding Numbered Paragraph, wherein the conveyor module base includes a rotary drive for rotating the conveyor support relative to the conveyor module base about the rotation axis.

Numbered Paragraph 8. A method of operating a rotatable conveyor module, wherein the conveyor module includes a conveyor belt configured to travel along a belt path, the belt path including a product support portion having first and second distal ends, and a belt support structure arranged to support the conveyor belt at the first and second distal ends, and the method comprises the steps of:
driving the conveyor belt in a first direction relative to the belt support structure;
pausing the conveyor belt motion;
tilting the belt support structure about a pivot axis relative to an initial position so as to lower one of the first and second distal ends and raise the other of the first and second distal ends;
rotating the belt support structure through an angle of 180° about a rotation axis that is perpendicular to the pivot axis;
tilting the belt support structure about the pivot axis to return it to the initial position; and driving the conveyor belt relative to the belt support structure in a second direction opposite to the first direction.

Numbered Paragraph 9. A method of Numbered Paragraph 8, wherein the rotatable conveyor module forms part of a food processing line,
the step of driving the conveyor belt in a first direction carries a food product onto the module from an upstream module of the processing line,
the step of pausing the belt motion occurs with the food product lying on the product support portion in a first rotational orientation, and
the step of driving the conveyor belt in a second direction opposite to the first direction carries the food product off the rotatable conveyor module towards a downstream module of the processing line and occurs when the product support portion is in a second rotational orientation which is rotated through 180° about an axis parallel to the rotation axis relative to its first rotational orientation.

Numbered Paragraph 10. A method of Numbered Paragraph 9, wherein the step of tilting the belt support structure about a pivot axis relative to the initial position so as to lower one distal end and raise the other distal end acts to lower the distal end that is at an end adjacent to the upstream module of the processing line.

1. A rotatable conveyor module for a food product processing line, comprising:
a conveyor module base;
a conveyor support which is carried by the conveyor module base and rotatable relative to the conveyor module base about a rotation axis; and
a conveyor belt configured to travel along a belt path, wherein the belt path includes a product support portion having first and second distal ends,
wherein the conveyor support comprises a belt support structure arranged to support the conveyor belt at the first and second distal ends of the product support portion of the belt path, and the belt support structure is pivotable relative to the conveyor module base about a pivot axis which is perpendicular to the rotation axis and spaced from the first and second distal ends, so as to lower one distal end and raise the other.

2. A conveyor module of claim 1, wherein the conveyor support is rotatable through at least 180° about the rotation axis.

3. A conveyor module of claim 1, further comprising a belt drive operable to selectively drive the conveyor belt in opposite first and second directions around the belt path.

4. A conveyor module of claim 1, wherein the conveyor support comprises a base portion and a tilt actuator for pivoting the belt support structure relative to the base portion.

5. A conveyor module of claim 1, further comprising a belt drive operable to selectively drive the conveyor belt in opposite first and second directions around the belt path,
wherein the conveyor support comprises a base portion and a tilt actuator for pivoting the belt support structure relative to the base portion,
wherein the belt drive is mounted on the base portion.

6. A conveyor module of claim 4, wherein the base portion is supported from one lateral side only of the conveyor belt.

7. A conveyor module of claim 1, wherein the conveyor module base comprises a rotary drive for rotating the conveyor support relative to the conveyor module base about the rotation axis.

8. A method of operating a rotatable conveyor module, wherein the conveyor module includes a conveyor belt configured to travel along a belt path, the belt path including a product support portion having first and second distal ends, and a belt support structure arranged to support the conveyor belt at the first and second distal ends, and the method comprises the steps of:
driving the conveyor belt in a first direction relative to the belt support structure;
pausing the conveyor belt motion;
tilting the belt support structure about a pivot axis relative to an initial position so as to lower one of the first and second distal ends and raise the other of the first and second distal ends;
rotating the belt support structure through an angle of 180° about a rotation axis that is perpendicular to the pivot axis;
tilting the belt support structure about the pivot axis to return it to the initial position; and
driving the conveyor belt relative to the belt support structure in a second direction opposite to the first direction.

9. A method of claim 8, wherein the rotatable conveyor module forms part of a food processing line,
the step of driving the conveyor belt in a first direction carries a food product onto the module from an upstream module of the processing line,
the step of pausing the belt motion occurs with the food product lying on the product support portion in a first rotational orientation, and
the step of driving the conveyor belt in a second direction opposite to the first direction carries the food product off the rotatable conveyor module towards a downstream module of the processing line and occurs when the product support portion is in a second rotational orientation which is rotated through 180° about an axis parallel to the rotation axis relative to its first rotational orientation.

10. A method of claim 9, wherein the step of tilting the belt support structure about a pivot axis relative to the initial position so as to lower one distal end and raise the other distal end acts to lower the distal end that is at an end adjacent to the upstream module of the processing line.
